(19) United States
(12) Patent Application Publication
(10) Pub. No.: US 2015/0014886 A1
(43) Pub. Date: Jan. 15, 2015

(54) PREFORMED FORMWORK FOR FORMING CONCRETE FLOOR SLAB FOR A HEIGHT ADJUSTABLE SHIPPING CONTAINER BUILDING STURCTURE

(71) Applicant: LIFTING POINT PTY LTD, Penrith, New South Wales (AU)

(72) Inventor: Nicholas Bruce Mullaney, Marulan (AU)

(73) Assignee: LIFTING POINT PTY LTD., Penrith, New Sosuth Waes (AU)

(21) Appl. No.: 14/379,219

(22) PCT Filed: Feb. 15, 2013
(86) PCT No.: PCT/AU2013/000127

§ 371 Date: Aug. 15, 2014

(30) Foreign Application Priority Data
Feb. 17, 2012 (AU) 2012900570

(51) Int. Cl. E04G 11/36; B28B 13/00

(52) U.S. Cl. CPC E04G 11/36; B28B 13/00
USPC 264/299; 249/13

(57) ABSTRACT

A preformed formwork for forming concrete floor slab for a height adjustable shipping container building structure having spaced apart frame side beams, spaced apart end beams and fork lifting supports. Reinforcing is situated within the internal area of the frame and attached to the side and end beams. A wall receiving feature on the external surface of the side and end beams accommodates attaching a portion of wall panel to the end and side beams. Columns are supported at the corners of the frame. The preformed formwork is dimensioned to equal the floor area of a shipping container so the preformed formwork is able to be easily transported within a height adjustable shipping container containing building components and able to be readily and easily erected and assembled as ether a ground floor or upper level floor of a building structure prior to been formed in to a concrete slab.

### FIELD OF THE INVENTION

The invention relates to a Preformed Formwork for Forming Concrete Floor Slab for a Height Adjustable Shipping Container Building Structure.

### BACKGROUND OF INVENTION

A problem with existing methods of shipping standard shipping containers lies in the height and transport costs of a product which does not take up the full space within the container particularly where the container is to be used as some form of accommodation.

In such cases the interior of the container is often almost empty but because the eventual residential height in the container is full height the transport costs are high.

Equally, where accommodation which is greater than the height of a shipping container must be provided the only real option is to provide it as two containers, one without floor, which must be mounted on top of each other.

Typically timber floors are currently used in shipping containers or other portable structures used as building structures, however this is typically unsuitable for the intended purposes in domestic housing situations or other accommodation and/or commercial situations because a timber floor has drawbacks in certain situations, such as a timber floor can be affected in a negative way by moisture, insect attack and has to be supported at a height above ground to avoid any potential flooding or water damage.

Also timber floors need to be supported at a height so that visual inspections can be conducted to ascertain the condition and maintenance of the floor,

As well building structures using a timber floor are more prone to be uplifted during serve weather conditions such high winds and tornados.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### OBJECT OF THE INVENTION

It is an object of the invention to provide a preformed formwork for forming concrete floor slab for a height adjustable shipping container building structure that ameliorates some of the disadvantages and limitations of the known art or at least provide the public with a useful choice.

### SUMMARY OF INVENTION

In a first aspect the invention relates to a method of constructing a floor slab within a shipping container by providing a perimeter tray at the lower edges of the container, and providing within the perimeter tray of an assembled container a grid of reinforcing elements adapted to act as reinforcing for a pourable settable floor material.

In a second aspect the invention relates to a preformed formwork for forming concrete floor slab for a height adjustable shipping container building structure, the preformed formwork includes a frame having:
(i) spaced apart side beams,
(ii) spaced apart end beams,
(iii) fork lifting support means that equally spaced apart from the centre of the frame extending between the spaced apart side beams,
(iv) reinforcing means situated within the internal area of the frame and attached to internal surface of the side and end beams,
(v) wall receiving means on the external surface of the side and end beams wherein the wall receiving means is adapted to accommodate, support and attach a portion of wall panel; and
(vi) column engaging portions situated at the corners of the frame
   wherein, the preformed formwork is dimensioned to equal the floor area of a standard shipping container such that the preformed formwork is able to be readily and easily transported within a height adjustable shipping container containing building components and able to be readily and easily erected and assembled as ether a ground floor or upper level floor of a building structure prior to been formed in to a concrete slab.

Preferably, the fork lifting support means are compression plates that are hollow to accommodate the forks of a fork lift for the transportation of the preformed formwork.

Preferably, the hollow compression plates are adapted to act as service ducts when the preformed formwork is erected and part of a building structure.

Preferably, spaced apart joists extend between the side beams.

Preferably, the reinforcing means is a reinforcing mesh that is situated in the upper region of the frame of the preformed formwork.

Preferably, the reinforcing means is held in place by internal ridges or projections on the inner surface of the side and end beams

Preferably, the wall receiving means are channels, recess, slots, ridges and projections on the exterior surface of the side and end beams.

Preferably, the interior of the preformed formwork capable of receive a pourable settable material.

Preferably, the pourable settable material is cement.

Any other aspect herein described.

### BRIEF DESCRIPTION

The invention will now be described, by way of example only, by reference to the accompanying drawings:

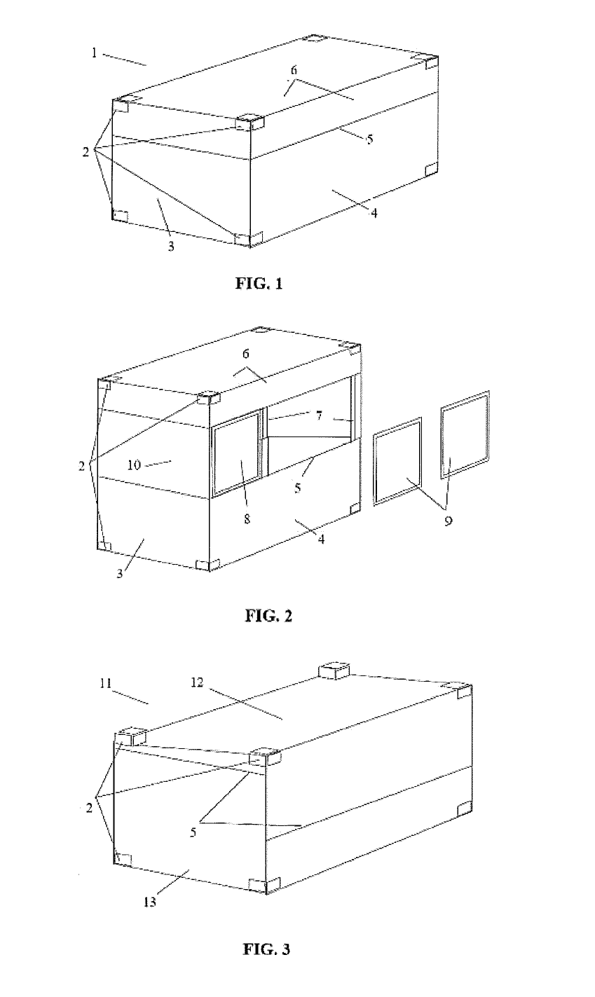

FIG. 1 is a height adjustable shipping container in accordance with an embodiment of the invention.

FIG. 2 is the container of FIG. 1 in an expanded position.

FIG. 3 is a variation of the container of FIG. 1.

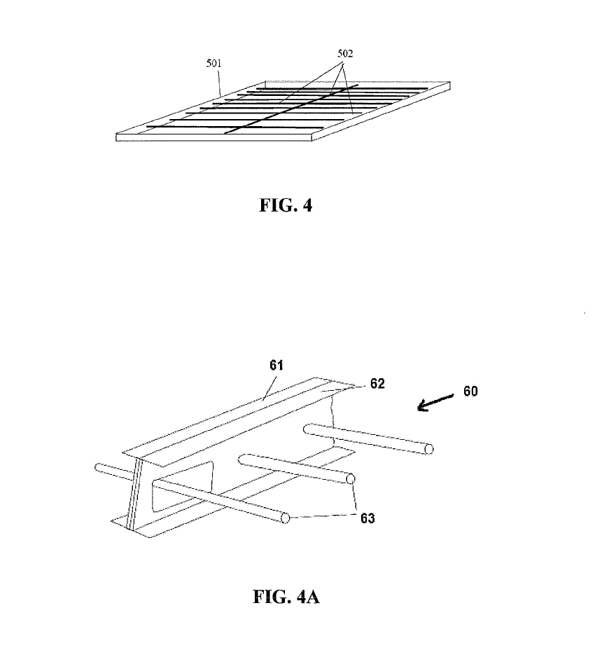

FIG. 4 is a prefabricated floor assembly suitable for a container.

FIG. 4A is a detail of a joint between two prefabricated floor assemblies of FIG. 4.

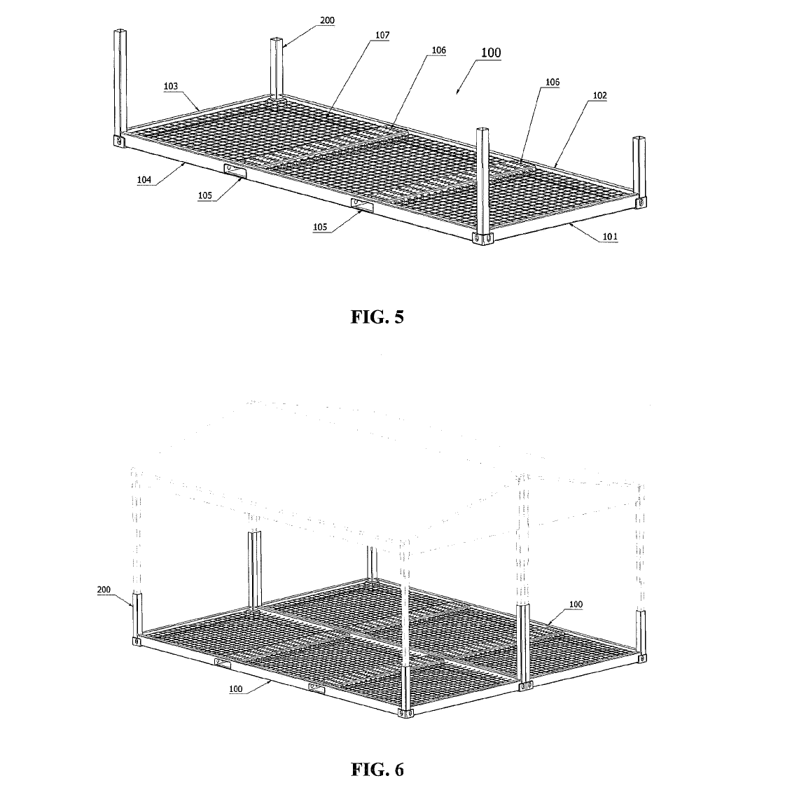

FIG. 5 is a perspective view of a floor slab in accordance to a preferred embodiment of the invention.

FIG. 6 is a perspective view of a floor of a building structure utilising the floor slab as shown in FIG. 5.

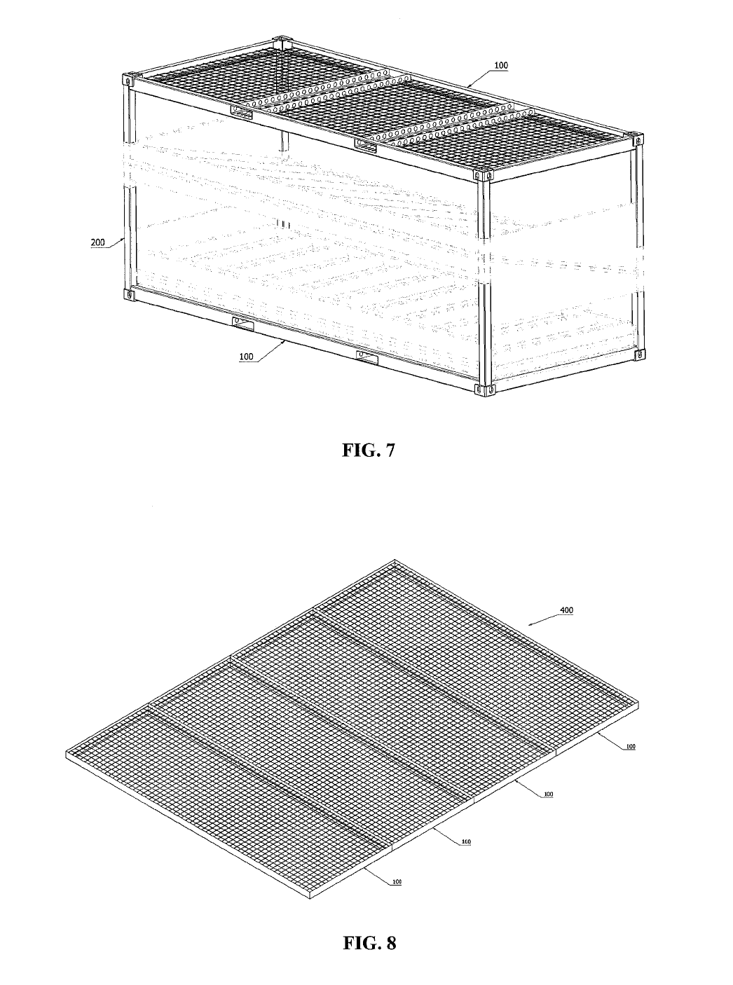

FIG. 7 is a perspective view an unerected shipping container incorporating the floor slab as shown in FIG. 5.

FIG. 8 is a perspective view of four floor slabs connected together.

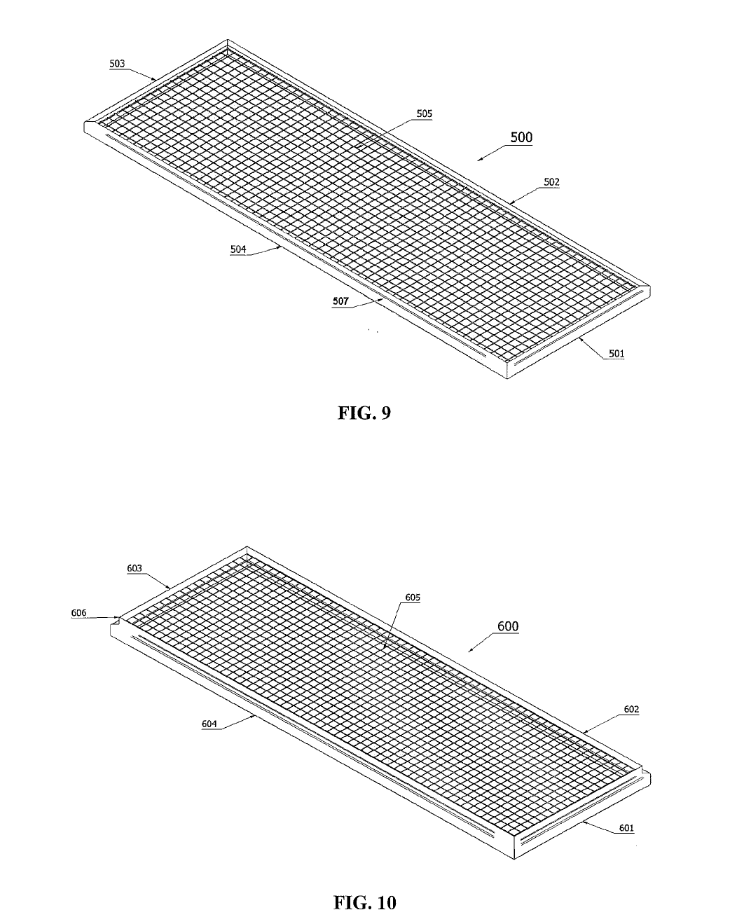

FIG. 9 is a perspective view of a floor slab in accordance to an alternative embodiment of the invention.

FIG. 10 is a perspective view of a floor slab in accordance to another embodiment of the invention.

FIG. 11 is a perspective view of a floor slab in accordance to a further embodiment of the invention.

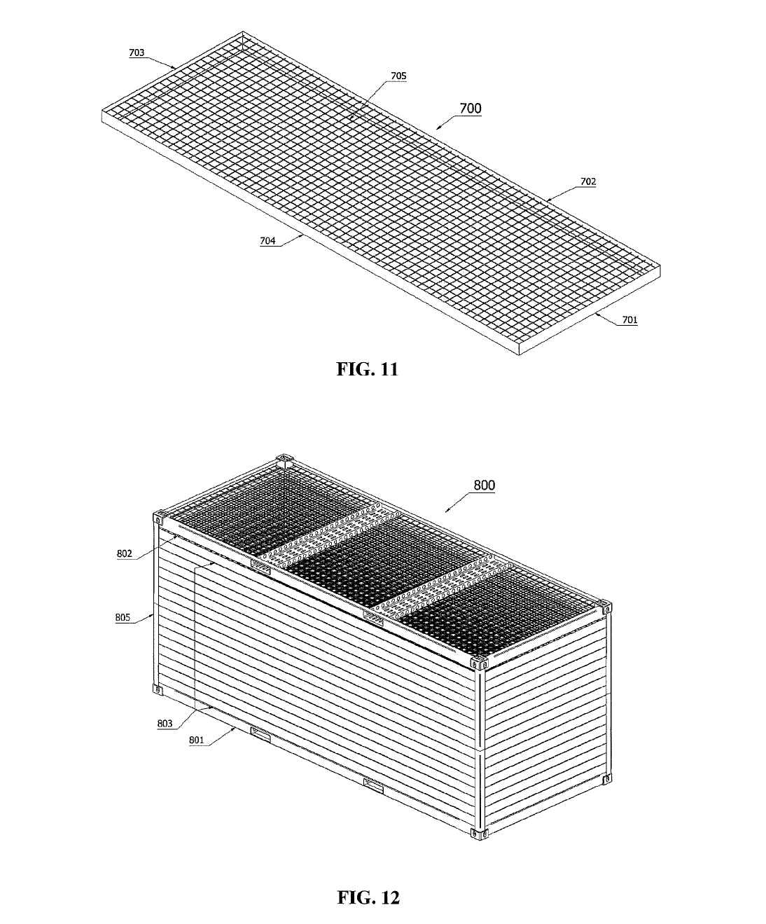

FIG. 12 is a perspective view of a stack of floor slabs.

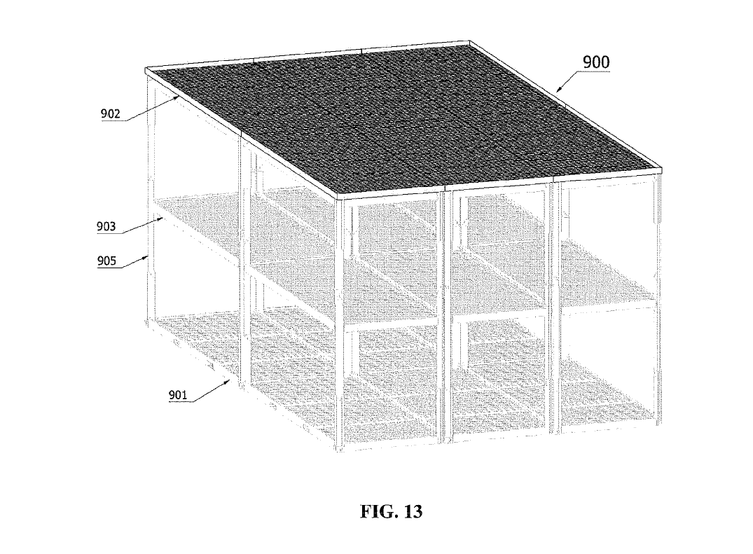

FIG. 13 is a perspective view of a building structure incorporating the floor slabs of the invention

### DESCRIPTION OF THE PREFERRED EMBODIMENT(S)

The following description will describe the invention in relation to preferred embodiments of the invention, namely a preformed formwork for forming concrete floor slab for a height adjustable shipping container building structure. The invention is in no way limited to these preferred embodiments as they are purely to exemplify the invention only and that possible variations and modifications would be readily apparent without departing from the scope of the invention.

The installation of a concrete floor for Building structures formed from shipping containers would create mass and secure the building to prevent uplift from wind and/or severe storms.

The use of a concrete floor is desirable when a shipping container built building structure is used as a hospital in emergency situations because timber floors would harbour bacteria and harmful germs, which is less of a problem with concrete floors.

The concrete floor can also be used for garages and may be washed out and decontaminated

The preformed formwork for forming concrete floor slab is well suited for areas of disaster relief and high risk building areas as it has qualities that addresses fire, storms and the fast construction of emergency housing.

Suspended concrete slabs may be formed. High rise buildings can include the concrete floor on top of a fully fitted out container which onto the suspended slab another container can be erected and fitted out.

Hollow columns and beams can be incorporated and that can be filled with concrete allowing for greater structural integrity and for fire rating.

The preformed formwork for forming concrete floor slab allows for reduction in weight and costs during transportation as the concrete is poured on site after installation.

Possible uses of the concrete slabs that are produced from the preformed formwork are floors, tilt slabs, roads, driveways with lighter steel to flex with uneven terrain.

In a situation of emergency relief and non permanent housing the floor slab could have a tray fixed underneath this could then have sand or available material placed on top and then when the use is complete the tray can be unfastened and the container removed. The tray would under the reinforcement mesh and would be bolted to the container frame whereby instead of using concrete, materials such as sand and rocks could be filled where the concrete would go. This would give the building mass and stop it been blown away. Once the emergency had passed the tray could be unbolted and the building lifted away leaving the sand and rock sitting on the tray.

A mezzanine floor can be incorporated thus allowing a timber floor and void area for services such as air conditioning and plumbing drainage etc that can be easily accessed

To construct the floor, reinforcement steel is fixed inside the preformed formwork and positioned so that concrete or another setting medium can be poured. The skill requirement for floor construction is low as there is a relatively small distance between the form boards, which are of a uniform height. This allows for easy leveling of the concrete. The cement for the concrete can also be transported in the container shell. Concrete would also provide a floor capable of being easily decontaminated and cleaned, which is essential for use in hospitals.

FIG. 1 shows a height adjustable shipping container 1 in which vertical corner rails extend to trucking and lifting points 2 at each end. Vertical walls on the exterior extend to cut line 5 forming partial end panel 3, partial side panel 4 and top panel and top side partial panels 6.

FIG. 2 shows the container of FIG. 1 in expanded form in which telescoping rails 7 have been expanded, a panel 11 formerly behind panel 3 has been pulled up into place and a window 8 formerly packed inside the container with windows 9 has been placed in the gap formed by expansion. Other panels or equipment which may have been packed within the container, such as doors, roller doors, ventilators, tables, etc can be fitted to the expanded container. Still others may be permanently fitted to the container before dispatch, such as lighting or plumbed fitments.

FIG. 3 shows a container 11 with a tilted top forming part of a peaked pitched roof 12 and an end panel 13. Cut lines 5 are offset, providing for different panel fitments at each cut. Typically any services required in the container (plumbing, electrical) are located adjacent a joint line to allow easy servicing and testing on installation. FIG. 4 shows a view of a telescoping column in expanded form. A lower portion 71 with engagement feature 73 for trucking or lifting has a cap 72 which slides down over portion 71. When slid down the engagement features 74 align with those at 73 to allow lifting the compacted container.

It is important that the compacted container still adheres to the measurements of a standard shipping container which means that in some cases a collapsed telescoping pole will still stand above part of the structure of a containerised building, as in FIG. 3.

FIG. 4 shows a view of a floor pan 50 for use with a container which is intended to be static. It consists of an edge structure 51 and reinforcing bars 52 to allow the pouring of concrete or some other settable pourable material into the pan at the final site, producing a reinforced concrete pad within the container.

FIG. 4A displays a method of carrying the reinforcing 63 through containers abutted and secured together so that edge rails 61, 62 are adjacent to render the concrete pad 60 continuous.

FIG. 5 shows the preferred embodiment of a preformed floor slab 100 that is easy to transport and be utilised on site when assembling a building structure from a height adjustable shipping container. The preformed floor slab 100 consists of a frame including side beams 102, 104 and end beams 101, 103. Situated and equally spaced apart from the centre of the floor frame are fork lifting support compression plates 106 that are hollow 105 to accommodate the forks of a fork lift for the transportation of the floor slab 100 either individually or when part of building components in a height adjustable shipping container (see FIG. 7) or a stack of floor slabs (see FIG. 12). The floor slab can include spaced apart joists (not shown) between the side beams 102, 104. The floor slab 100 includes a reinforcing mesh 107 that is situated in the upper region of the floor slab and is held in position by either the floor joists and/or on an internal ridge/projection on the inner surface of the side and end beams 101, 102, 103, 104. Also the corners of the floor slab configured and dimensioned to accommodate and support an end portion of a height adjustable column 200. The interior 105 of the support compression plates 106 can be used as service ducts once the floor slab is erected within a building structure. The inventive floor slab is able to be used in a ground floor situation (FIG. 6) or as upper level floor (FIG. 13) and multiple floor slabs can be joined side by side to increase the floor area (FIGS. 6, 8, 13). The view in FIG. 8 shows an alternative use as a foundation for a roadway.

The floor slab 100 is transported to a particular site either as part of building components in a height adjustable shipping container (see FIG. 7) or a stack of floor slabs (see FIG. 12). Once on site the floor is situated in the desired location and once the shell of the building structure is formed (FIG. 6, FIG. 12) a pourable, settable medium such as cement is then poured (or this can be done prior to the other parts of the building structure being erected) to form a concrete floor. The columns which are hollow also have cement poured therein thus forming a rigid and structural sound structure. The skill requirement for floor construction is low as there is a relatively small distance between the form boards, which are of a uniform height. This allows for easy leveling of the concrete. The cement for the concrete can also be transported within the collapsed container shell. Concrete would also provide a floor capable of being easily decontaminated and cleaned, which is essential for use in hospitals.

FIG. 6 shows a building structure consisting of two floor slabs 100 joined together with columns 200 positioned and attached to the corners of each slab 100.

FIG. 7 shows a height adjustable container containing building components including two floor slabs 100 for forming a building structure having a floor area equal to twice the floor area of two standard shipping containers.

FIG. 8 shows a four floor slabs 100 joined together side by side forming floor 400 suitable for a building structure or for a roadway.

FIG. 9 shows a floor slab 500 including side beams 502, 504 and end beams 501, 503. The floor slab 500 includes a reinforcing mesh 505 that is situated in the upper region of the floor slab and is held in position by either the floor joists and/or on an internal ridge/projection on the inner surface of the side and end beams 501, 502, 503, 504. The outer surface of the side and end beams 501, 502, 503, 504 has wall receiving recess for accommodating and supporting wall panels of building.

FIG. 10 shows a floor slab 600 including side beams 602, 604 and end beams 601, 603. The floor slab 600 includes a reinforcing mesh 605 that is situated in the upper region of the floor slab and is held in position by either the floor joists and/or on an internal ridge/projection on the inner surface of the side and end beams 601, 602, 603, 604. The outer surface of the side and end beams 601, 602, 603, 604 has wall receiving channel/ledge 606 for accommodating and supporting wall panels of building.

FIG. 11 shows a floor slab 700 including side beams 702, 704 and end beams 701, 703. The floor slab 700 includes a reinforcing mesh 705 that is situated in the upper region of the floor slab and is held in position by either the floor joists and/or on an internal ridge/projection on the inner surface of the side and end beams 701, 702, 703, 704. The outer surface of the side and end beams 701, 702, 703, 704 are angled to assist in accommodating and supporting wall panels of building.

FIG. 12 shows a stack 800 of floor slabs 801, 802, 803 with height adjustable columns 805 at the corners thereof ready for shipping and transportation.

FIG. 13 shows the shell of a multi storey building structure 900 consisting of ground floor slabs 901 and upper level floor slabs 902, 903 supported by extended columns 905. The upper level floor slab will normally not be installed inside the building, it will be installed above and outside thus not causing damage to the internally finished building shell.

Other uses of the preformed formwork can be to form tilt slabs, driveways and roads.

### ADVANTAGES

a) Faster and easy to install

b) Able to be used in high rise buildings

c) Able to be installed above the units eliminating possible damage

d) Extremely strong and fast construction

e) Reduce trades on site and material handling

f) Fire rated and structural

g) Combination of steel and concrete together assist in earthquake resistance

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A method of constructing a floor slab within a shipping container by providing a perimeter preformed formwork at the lower edges of the container, and providing within the perimeter preformed formwork of an assembled container a grid of reinforcing elements in the form of a reinforcing mesh that is adapted to be situated within the frame of the preformed formwork and is adapted to act as reinforcing for a pourable settable floor material.

2. A preformed formwork for forming concrete floor slab for a height adjustable shipping container building structure, the preformed formwork includes a frame having:
spaced apart side beams,
spaced apart end beams,
reinforcing means situated within the internal area of the frame and attached to internal surface of the side and end beams, the reinforcing means includes a reinforcing mesh that is adapted to be situated within the frame of the preformed formwork,
wall receiving means on the external surface of the side and end beams wherein the wall receiving means is adapted to accommodate, support and attach a portion of wall panel; and
column engaging portions situated at the corners of the frame
wherein, the preformed formwork is dimensioned to equal the floor area of a standard shipping container such that the preformed formwork is able to be readily and easily transported within a height adjustable shipping container containing building components and able to be readily and easily erected and assembled as ether a ground floor or upper level floor of a building structure prior to been formed in to a concrete slab.

3. The preformed formwork as claimed in claim 2, wherein the preformed formwork includes fork lifting support means that are equally spaced apart from the centre of the frame extending between the spaced apart side beams.

4. The preformed formwork as claimed in claim 3, wherein the fork lifting support means are compression plates that are hollow to accommodate the forks of a fork lift for the transportation of the preformed formwork.

5. The preformed formwork as claimed in claim 4, wherein the hollow compression plates are adapted to act as service ducts when the preformed formwork is erected and part of a building structure.

6. The preformed formwork as claimed in claim 2, wherein spaced apart joists extend between the side beams.

7. The preformed formwork as claimed in claim 2, wherein the the reinforcing mesh is situated in the upper region of the frame of the preformed formwork.

8. The preformed formwork as claimed in claim 7, wherein the reinforcing means is held in place by internal ridges or projections on the inner surface of the side and end beams

9. The preformed formwork as claimed in claim 2, wherein, the wall receiving means are channels, recess, slots, ridges and projections on the exterior surface of the side and end beams.

10. The preformed formwork as claimed in claim 2, wherein the interior of the preformed formwork is capable of receiving a pourable settable material.

11. The preformed formwork as claimed in claim 10, wherein the pourable settable material is cement.
